(19) United States
(12) Patent Application Publication
(10) Pub. No.: US 2019/0185602 A1
(43) Pub. Date: Jun. 20, 2019

(54) UV-CURING ACRYLIC RESIN COMPOSITIONS FOR THERMOFORMABLE HARD COAT APPLICATIONS

(71) Applicant: Rohm and Haas Electronic Materials LLC, Marlborough, MA (US)

(72) Inventors: Lujia Bu, Marlborough, MA (US); Yusuke Matsuda, Shrewsbury, MA (US); Michael Mulzer, Marlborough, MA (US)

(21) Appl. No.: 15/843,317

(22) Filed: Dec. 15, 2017

(51) Int. Cl. C08F 222/22; C09D 135/02

(52) U.S. Cl. CPC C08F 222/22; C08F 2800/20; C09D 135/02

(57) ABSTRACT

The present invention provides ultraviolet (UV) curing acrylic compositions for use in making thermoformable hard coats for curved optical displays comprising: (a) one or more multifunctional (meth)acrylate diluents chosen from (a1) an aliphatic trifunctional (meth)acrylate monomer; (a2) an aliphatic tetrafunctional (meth)acrylate monomer; or (a3) an aliphatic pentafunctional (meth)acrylate monomer; (b) from 3 to 30 wt. %, based on the total weight of monomer solids, of one or more one (meth)acrylate monomer containing an isocyanurate group; (c) from 5 to 40 wt. %, based on the total weight of monomer solids, of one or more aliphatic urethane (meth)acrylate functional oligomer having from 6 to 12 (meth)acrylate groups; (d) from 2 to 10 wt. %, based on total monomer solids, of one or more UV radical initiators; and (e) one or more organic solvents for the monomer composition. The composition has a viscosity measured by Anton Parr ASVM 3001 digital viscometer at 50 wt. % solids of from 10 to 200 centipoise (cPs).

The present invention relates to compositions for use in ultraviolet (UV) curing coatings. More particularly, it relates to compositions comprising a UV curing reaction mixture of one or more, or, preferably, two or, more preferably, three of the multi-ethylenically unsaturated (meth)acrylate diluents chosen from one having three, one having four, and one having five (meth)acrylate groups, the compositions comprising one or more isocyanurate group containing multi-ethylenically unsaturated (meth)acrylates and one or more urethane group containing multi-ethylenically unsaturated (meth)acrylates having no fewer than 6 and having up to 12 (meth)acrylate groups.

Smart phones and other mobile or portable devices equipped with an optical display having a touch sensor with an exposed viewing surface made from glass or clear plastic films. These display surfaces have either poor impact resistance or poor abrasion resistance. During use, the viewing face of the display is susceptible to cracks, scratches, abrasion and smudges, which can cause the display to lose resolution and clarity, and sometimes becoming unreadable or inoperative. To protect such displays, multilayer protective films or coatings have been used containing a hard coat, base substrate and an optical adhesive. The hard coat provides hardness, scratch resistance and finger print removal; the base substrate provides impact resistance; and the adhesive ensures that the film firmly attaches to the device screen.

Recently, curved displays have emerged in smartphones, in part leading to increasing demand for curved hard coat films to protect the display top surface. Such curved hard coat films can be fabricated via thermo-molding processes to conform to curved display shapes. However, conventional hard coat films are too rigid for use as thermo-formable materials; and thermo-formable hard coat films available on the market are too soft for protecting optical displays, and are very easily damaged.

U.S. Pat. No. 6,489,376, to Khudyakov et al., discloses UV curable coating compositions comprising (a) a radiation curable oligomer, such as 50 to 95 wt. % of monomers, of a urethane acrylate oligomer, (b) a photoinitiator, and (c) a mixture of reactive diluents, such as in the amount of from 5 to 50 wt. % of monomers, comprising (i) at least one mono- or di-functional reactive diluent monomer and (ii) at least one polyfunctional reactive diluent. The compositions provide hard coats for optical fiber. Difunctional urethane acrylates are disclosed which are urethane oligomers that contain two or more urethane linkages. The compositions fail to provide adequate combination of hardness and flexibility needed for use in making curved films that behave like hard coats for protecting flat optical displays

The present inventors have endeavored to solve the problem of providing thermoformable hard coating compositions for use in making curved and custom shapable films that behave like hard coats for protecting flat optical displays.

### STATEMENT OF THE INVENTION

1. In accordance with the first aspect of the present invention, an ultraviolet (UV) curing acrylic composition for use in making thermoformable hard coats for curved optical displays comprises (a) one or more, preferably, two or more, or, more preferably, all three multifunctional (meth)acrylate diluents chosen from (a1) an aliphatic trifunctional (meth)acrylate, preferably, acrylate, monomer (a2) an aliphatic tetrafunctional (meth)acrylate monomer; or (a3) an aliphatic pentafunctional (meth)acrylate, preferably, acrylate, monomer; (b) from 3 to 30 wt. %, or, preferably, from 10 to 30, based on the total weight of monomer solids, of one or more one (meth)acrylate, preferably, acrylate, monomer containing an isocyanurate group; (c) from 5 to 40 wt. %, or, preferably, from 10 to 40 wt. %, based on the total weight of monomer solids, of one or more aliphatic urethane (meth)acrylate, preferably, acrylate, functional oligomer having no fewer than 6 and up to 12 or, preferably, from 6 to 10 (meth)acrylate, preferably, acrylate, groups; (d) from 2 to 10 wt. % or, preferably, from 3 to 7 wt. %, based on total monomer solids, of one or more UV radical initiators, such as, for example, benzophenones, benzils (1,2 diketones), thioxanthones, (2-benzyl-2-dimethylamino-1-[4-(4-morpholinyl) phenyl]-1-butanone), 2,4,6-trimethyl-benzoyl)-diphenyl phosphine oxide, 1-hydroxy-cyclohexyl-phenyl-ketone, 2-hydroxy-2-methyl-1-phenyl-1-propanone), oligomeric 2-hydroxy-2-methyl-1-[4-(1-methylvinyl)phenyl]propanones, dihydro-5-(2-hydroxy-2-methyl-1-oxopropyl)-1,1,3-trimethyl-3-(4-(2-hydroxy-2-methyl-1-oxopropyl)phenyl)-1H-indenes, and bis-benzophenones, or, preferably, oligomeric 2-hydroxy-2-methyl-1-[4-(1-methylvinyl)phenyl]propanones, dihydro-5-(2-hydroxy-2-methyl-1-oxopropyl)-1,1,3-trimethyl-3-(4-(2-hydroxy-2-methyl-1-oxopropyl)phenyl)-1H-indenes, or α-[(4-benzoylphenoxy)-acetyl]-w-[[2-(4-benzoylphenoxy)acetyl]oxy]-poly(oxy-1,4-butanediyl)); (e) one or more organic solvents for the monomer composition, such as a ketone, for example, methyl ethyl ketone; a glycol ether; an aromatic hydrocarbon; an aromatic alcohol or an alkanol, wherein the composition has a viscosity measured in accordance with ASTM D7042-16 (2016) using a viscometer (ASVM3001, Anton Parr, Ashland, Va.) at 25° C. and at 50 wt. % solids in the organic solvent, such as propylene glycol methyl ether acetate (PGMEA), ranging from 10 to 200 centipoise (cPs) or, preferably, from 20-150 cPs, wherein the total amount of monomer and functional oligomer solids amounts to 100%.

2. In accordance with the UV curing acrylic composition of the first aspect of the present invention as in item 1, above, wherein the composition comprises (a) a multifunctional (meth)acrylate diluent of the (a1) one or more aliphatic trifunctional (meth)acrylate, preferably, acrylate, monomer, in the amount of from 3 to 25 wt. % or, preferably, from 3 to 15 wt. %, based on total monomer solids, wherein the total amount of monomer and functional oligomer solids amounts to 100%.

3. In accordance with the UV curing acrylic composition of the first aspect of the present invention as in any one of items 1 or 2, above, wherein the composition comprises (a) a multifunctional (meth)acrylate diluent of the (a2) one or more aliphatic tetrafunctional (meth)acrylate, preferably, acrylate, monomer, in the amount of from 3 to 25 wt. % or, preferably, from 3 to 19 wt. %, based on total monomer solids, wherein the total amount of monomer and functional oligomer solids amounts to 100%.

4. In accordance with the UV curing acrylic composition of the first aspect of the present invention as in any one of items 1, 2 or 3, above, wherein the composition comprises (a) a multifunctional (meth)acrylate diluent of the (a3) one or more aliphatic pentafunctional (meth)acrylate, preferably, acrylate, monomer, in the amount of from 3 to 25 wt. % or, preferably, 3 to 15 wt. %, based on total monomer solids, wherein the total amount of monomer and functional oligomer solids amounts to 100%.

5. In accordance with the UV curing acrylic composition of the first aspect of the present invention as in item 1, above, wherein the composition comprises from 9 to 70 wt. % in total or, preferably, from 9 to 60 wt. % in total, based on total monomer solids, of the (a) multifunctional (meth)acrylate diluent which is two or more of the monomer (a1), the monomer (a2) or the monomer (a3), wherein the total amount of monomer and functional oligomer solids amounts to 100%.

6. In accordance with the UV curing acrylic composition of the first aspect of the present invention as in any one of items 1 to 5, above, wherein the composition comprises 20 wt. % or less or, preferably, 15 wt. % or less or, more preferably, 13 wt. % or less in total of mono- and di-functional (meth)acrylates, based on total monomer solids, wherein the total amount of monomer and functional oligomer solids amounts to 100%.

7. In accordance with the UV curing acrylic composition of the first aspect of the present invention as in any one of items 1 to 6, above, wherein at least one (c) aliphatic urethane (meth)acrylate functional oligomer has a formula molecular weight of from 1,400 to 10,000 or, preferably, from 1,500 to 6,000, or, more preferably, wherein the reacted isocyanate (carbamate) content of the composition, as solids, of the one or more (c) aliphatic urethane (meth)acrylate, preferably, acrylate, functional oligomer ranges from 10 to 50 wt. %.

8. In accordance with the UV curing acrylic composition of the first aspect of the present invention as in any one of items 1 to 7, above, wherein the composition comprises from 0.1 to 20 wt. %, or, preferably, 15 wt. % or less or, more preferably, 13 wt. % or less as solids, of one or more thiol compounds chosen from (meth)acrylates, such as mercapto modified polyester acrylics, or thiols not containing (meth)acrylates.

9. In accordance with the UV curing acrylic composition of the first aspect of the present invention as in any one of items 1 to 8, above, wherein the amount of the (e) one or more organic solvents ranges from 10 to 90 wt. % or, preferably, from 25 to 60 wt. %, based on the total weight of the composition.

10. In accordance with the UV curing acrylic composition of the first aspect of the present invention as in any one of items 1 to 9, above, wherein the composition comprises in total 5 wt. % or less or, preferably, 3.5 wt. %, or less, as solids, of inorganic compounds, such as all fillers or extenders, for example alumina nanoparticles having an average particle size of 100 nm or less in diameter.

11. In accordance with the UV curing acrylic composition of the first aspect of the present invention as in any one of items 1 to 9, above, wherein after UV curing with a UV dosage of 480, 120, 35, and 570 mJ/cm² in the UVA, UVB, UVC, and UVV regimes, respectively, with a Fusion Systems UV belt system device (Heraeus Noblelight American, LLC, Gaithersburg, Md.), which is equipped with D lamp at a speed of 0.24 m/s after 4 passes of the UV dosage, a cured coating of a thickness of 50 micron on a poly(ethylene terephthalate) (PET) substrate and cut to specimens 15 mm wide and of a 60 mm gauge length loaded in tension into the pneumatic grips of a mechanical tester preloaded to 1 MPa in tensile stress and tested at a loading rate of 1 mm/min until a vertical crack was observed has an elongation at break of at least 2% or, preferably, 4% or more.

In a second aspect, the present invention comprises methods of making a coating from the UV curing acrylic composition as in any one of items 1 to 11 above, wherein the methods comprise applying the composition to a mold or a substrate, such as a polymeric release layer, at a temperature of from 60 to 150° C. to form a film, and curing the film with UV containing radiation or, preferably, a UV lamp at dosage from 100 mJ/cm² to 2000 mJ/cm² or, preferably, from 100 mJ/cm² to 1000 mJ/cm².

In accordance with the methods of making a coating of the second aspect of the present invention, wherein the applying comprises any one of drawing down or spraying the UV curing acrylic composition onto the substrate or dipping the substrate into a fluid comprising the UV curing acrylic composition.

In accordance with the methods of making a coating of the second aspect of the present invention, wherein the substrate comprises a silicon release layer, a polyester film, such as poly(ethylene terephthalate) (PET) or a polyimide film. In a third aspect, the present invention comprises hard coat coatings of, in copolymerized form, (a) one or more, or, preferably, two or more, or, more preferably, three or more multifunctional (meth)acrylate diluents chosen from (a1) an aliphatic trifunctional (meth)acrylate, preferably, acrylate, monomer; (a2) an aliphatic tetrafunctional (meth)acrylate, preferably, acrylate, monomer; or (a3) an aliphatic pentafunctional (meth)acrylate, preferably, acrylate, monomer; (b) from 3 to 30 wt. %, or, preferably, from 10 to 30, based on the total weight of polymerized monomer solids, of one or more one (meth)acrylate, preferably, acrylate, monomer containing an isocyanurate group; (c) from 5 to 40 wt. %, or, preferably, from 10 to 40 wt. %, based on the total weight of polymerized monomer solids, of one or more aliphatic urethane (meth)acrylate, preferably, acrylate, functional oligomer having no fewer than 6 and up to 12 or, preferably, from 6 to 10 (meth)acrylate, preferably, acrylate, groups; and (d) from 2 to 10 wt. % or, preferably, from 3 to 7 wt. %, based on total polymerized monomer solids, of one or more UV radical initiators, such as, for example, benzophenones, benzils (1,2 diketones), thioxanthones, (2-benzyl-2-dimethylamino-1-[4-(4-morpholinyl) phenyl]-1-butanone), 2,4,6-trimethyl-benzoyl)-diphenyl phosphine oxide, 1-hydroxy-cyclohexyl-phenyl-ketone, 2-hydroxy-2-methyl-1-phenyl-1-propanone), oligomeric 2-hydroxy-2-methyl-1-[4-(1-methylvinyl)phenyl]propanones, dihydro-5-(2-hydroxy-2-methyl-1-oxopropyl)-1,1,3-trimethyl-3-(4-(2-hydroxy-2-methyl-1-oxopropyl)phenyl)-1H-indenes, and bis-benzophenones, such as α-[(4-benzoylphenoxy)acetyl]-w-[[2-(4-benzoylphenoxy)acetyl]oxy]-poly(oxy-1,4-butanediyl)) or, preferably, oligomeric 2-hydroxy-2-methyl-1-[4-(1-methylvinyl)phenyl]propanones, dihydro-5-(2-hydroxy-2-methyl-1-oxopropyl)-1,1,3-trimethyl-3-(4-(2-hydroxy-2-methyl-1-oxopropyl)phenyl)-1H-indenes, or α-[(4-benzoylphenoxy)acetyl]-w-[[2-(4-benzoylphenoxy)acetyl]oxy]-poly(oxy-1,4-butanediyl)) (CAS 515136-48-8).

In accordance with the hard coating of the third aspect of the present invention, the coatings comprise, in copolymerized form, from 3 to 25 wt. % or, preferably, from 3 to 15 wt. %, based on total polymerized monomer solids, of the (a1) one or more aliphatic trifunctional (meth)acrylate, preferably, acrylate, monomer.

In accordance with the hard coating of the third aspect of the present invention, the coatings comprise, in copolymerized form, from 3 to 25 wt. % or, preferably, from 3 to 15 wt. %, based on the total weight of polymerized monomer solids, of the (a2) one or more aliphatic tetrafunctional (meth)acrylate, preferably, acrylate, monomer.

In accordance with the hard coating of the third aspect of the present invention, the coatings comprise, in copolymerized form, from 3 to 25 wt. % or, preferably, 3 to 15 wt. %, based on the total weight of polymerized monomer solids, of the (c) one or more aliphatic pentafunctional (meth)acrylate, preferably, acrylate, monomer.

In accordance with the hard coating of the third aspect of the present invention, the coatings comprise, in copolymerized form, from 9 to 70 wt. % in total or, preferably, from 9 to 60 wt. % in total, based on the total weight of polymerized monomer solids, of the a multifunctional (meth)acrylate diluent chosen from one or more, or, preferably, two or more, or, more preferably, all three of (a1) one or more aliphatic trifunctional (meth)acrylate, preferably, acrylate, monomer, (a2) the one or more aliphatic tetrafunctional (meth)acrylate, preferably, acrylate, monomer or (a3) the one or more aliphatic pentafunctional (meth)acrylate, preferably, acrylate, monomer.

In accordance with the hard coating of the third aspect of the present invention, the coatings comprise, in copolymerized form, 20 wt. % or less or, preferably, 15 wt. % or less or, more preferably, 10 wt. % or less in total, based on the total weight of polymerized monomer solids, of mono- and di-functional (meth)acrylates.

In accordance with the hard coating of the third aspect of the present invention, wherein at least one of the (c) aliphatic urethane (meth)acrylate, preferably, acrylate, functional oligomer, in copolymerized form, has a formula molecular weight of from 1,400 to 10,000 or, preferably, from 1,500 to 6,000, or, more preferably, wherein the reacted isocyanate (carbamate) content of the hard coating comprises the one or more (c) aliphatic urethane (meth)acrylate functional oligomer, in copolymerized form, ranges from 10 to 50 wt. %.

Preferably, in accordance with the compositions of the present invention, thiol compounds can be used to increase the water contact angle of the UV cured coatings made from the compositions. A suitable thiol compound may be a (meth)acrylate such as a mercapto modified polyester acrylic, sold as EBECRYL™ LED 02 (Allnex Coating Resins, Frankfurt am Main, Germany).

In accordance with the hard coating of the third aspect of the present invention, the coatings comprise, wherein the hard coating comprises in total 5 wt. % or less or, preferably, 3.5 wt. %, or less, based on the total weight of the coating, of inorganic compounds, such as all fillers or extenders, for example alumina nanoparticles having an average particle size of 100 nm or less in diameter.

In accordance with the hard coating of the third aspect of the present invention, the coatings have some elongation at break. For example, after UV curing at a total exposure of around 480, 120, 35, and 570 mJ/cm² in the UVA, UVB, UVC, and UVV regimes, respectively, such as by curing for four passes at the speed of 0.24 m/s using a Fusion Systems P300MP™ lamp (Heraeus Noblelight) equipped with a with D bulb, the cured hard coating of a thickness of 50 micron has an elongation at break of at least 2% or, preferably, 4% or more, as measured by tensile testing when elongated together with an underlying 50 micron PET substrate (Melinex™ 462 polyester, Tekra, a Division of EIS, Inc., New Berlin, Wis.) at room temperature and a loading rate of 1 mm/min.

In accordance with the hard coating of the third aspect of the present invention, the coating comprises a transparent multilayer article of the hard coating over a protective polymer layer, such as one of PET, poly(methyl methacrylate), polyimides or polycarbonates, further wherein, the layer is adhered by a layer of an optical adhesive to a glass optical display.

All ranges are inclusive and combinable. For example, a weight percentage of from 0.1 to 1 wt. %, preferably, 0.2 wt. % or more, or, preferably, up to 0.6 wt. % includes ranges of from 0.1 to 0.2 wt. %, from 0.1 to 0.6 wt. %, from 0.2 to 0.6 wt. %, from 0.2 to 1.0 wt. %, or from 0.1 to 1.0 wt. %.

Unless otherwise indicated, any term containing parentheses refers, alternatively, to the whole term as if no parentheses were present and the term without them (i.e. excluding the content of the parentheses), and combinations of each alternative. Thus, the term “(meth)acrylate” refers to any of an acrylate, a methacrylate, and mixtures thereof.

Unless otherwise specified, all temperature units refer to room temperature (˜20-22° C.) and all pressure units refer to standard pressure.

As used herein, the term “ASTM” refers to the ASTM International of West Conshohocken, Pa.

As used herein, the term “average number of ethylenically unsaturated groups” in a multi-ethylenically unsaturated (meth)acrylate monomer composition is a weighted average number of ethylenically unsaturated groups in each of the monomers in that composition. Thus, for example, when such (meth)acrylate compositions comprise only one multi-ethylenically unsaturated acrylate monomer, the composition is said to comprise the average number of ethylenically unsaturated groups reported for that monomer in the monomer supplier's product literature, such as 4 for a tetraacrylate; and, for example, when a composition comprises a 50/50 wt. % monomer blend of each of a triacrylate and a tetraacrylate, the composition has monomer composition with an average of 3.5 ethylenically unsaturated groups.

As used herein, the term “calculated glass transition temperature (T_{g})” means the result determined by plugging the report glass transition temperature of the monomers of a given composition into the Flory-Fox Equation, as follows:

$$\frac{1}{{T}_{g}} = \frac{{w}_{1}}{{T}_{g , 1}} + \frac{{w}_{2}}{{T}_{g , 2}} .$$

The T_{g} values for a given monomer are available from the manufacturer or can be measured by DSC or DMA.

As used herein, the term “carbamate” refers to a urethane or (—RNCOOR′—) group which is the reaction product of an isocyanate group RNCO and an alcohol R′OH or other active hydrogen.

As used herein, the term “based on total monomer solids” includes both monomer solids and functional oligomer solids.

As used herein, unless otherwise indicated, the term “molecular weight” or “formula molecular weight” means a formula weight for a given material as reported by its manufacturer or, if so indicated, as determined by totaling the molar mass of a formula of the monomer. As used herein, the term “average molecular weight” refers to the molecular weight reported for a distribution of molecules in a given material, e.g. a polymer distribution.

As used herein, the term “elongation at break” refers to the result of testing a cured 50 micron thick coating on a poly(ethylene terephthalate) (PET) substrate, cut to specimens 15 mm wide and of a 100 mm long, wherein specimens of a 60 mm gauge length were loaded in tension into the pneumatic grips of a mechanical tester preloaded to 1 MPa in tensile stress (Instron™ model 33R4464, table top load frame, Instron, an ITW company, Norwood, Mass.) and tested at the loading rate of 1 mm/min until a vertical crack was observed. During the tensile test, the specimens were under a white LED light for easier crack detection. Once a crack is found in the specimens, the loading was immediately stopped and corresponding tensile strain was reported as elongation-to-break.

As used herein, unless otherwise indicated, the term “number of ethylenically unsaturated groups” in a multi-ethylenically unsaturated (meth)acrylate composition refers to the number of acrylate groups in that monomer according to the monomer or oligomer supplier's product literature.

As used herein, the term “reacted isocyanate (carbamate) content” means any carbamate (—NCOO—) group which has formed a urethane and includes the weight of the NCO moiety in the urethane as well as a single extra oxygen but not the corresponding hydrocarbyl or active hydrogen substituents of the carbamate, such as a polymer diol, or the content thereof.

As used herein, the term “solids” means any material other than water or ammonia that does not volatilize in use conditions, no matter what its physical state, and including all oligomers, monomers and all non-volatile additives. Solids excludes water and volatile solvents. Thus, liquid reactants that do not volatilize in use conditions are considered “solids”.

As used herein, the term “viscosity” means the result obtained in centipoises (cPs) in accordance with the ASTM D7042-16 (2016) method at 25° C. of a 50 wt. % solids solution of the indicated composition in the organic solvent, such as PGMEA as determined by a viscometer (ASVM3001, Anton Parr, Ashland, Va.) wherein a ˜1.5 mL solution was filled in a cell, which was cleaned with PMGMEA. The viscometer was calibrated using the certified reference standards as described in section 9.2 of ASTM D7042-16.

As used herein, the term “wt. %” stands for weight percent.

The present inventors have discovered a way to make UV curing acrylic coating compositions for colorless, transparent thermoformable hard coatings that provides hard coatings that exhibit hardness comparable to the conventional hard coats as well as thermo-formability so as to conform to a curved optical display. The hard coatings may be laminated or coated on an protective polymer layer, for example, PET, layer over a glass display screen. The thermoformable hard coatings can change shape at a high (˜50 to 160° C.) temp because they remain soft, even though not fluid. The flexibility of the hard coatings enables them to retain an aspect of softness at ambient temperature.

The hard coatings in accordance with the present invention are formed by curing an inventive UV curing acrylic composition. In the UV curing acrylic composition, the amount of aliphatic urethane (meth)acrylate functional oligomer remains high so as to avoid a brittle film. At the same time, the cured hard coatings in accordance with the present invention have a calculated glass transition temperature (T_{g}) of from 70 to 120° C.

In the UV curing acrylic composition in accordance with the present invention, the aliphatic urethane (meth)acrylate functional oligomer and the multi-ethylenically unsaturated monomers confer both flexibility and hardness to hard coat network through secondary bond interactions.

The methods of making the hard coatings in accordance with the present invention is temperature dependent because the substrate cannot be deformed. For example, the deformation temperature of PET is ˜0.150° C. If the UV curing acrylic compositions remain below the deformation temperature of the substrate, they will retain their shape after removal of a mold or after cooling.

In accordance with the UV curing acrylic composition of the first aspect of the present invention, the aliphatic urethane (meth)acrylate functional oligomer can be an aliphatic version of the compound of formula I, below, wherein R or R′ are branched and have (meth)acrylate groups at their termini to give a total of from 6 to 12 (meth)acrylates.

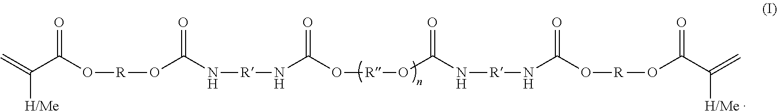

Preferably, in accordance with the present invention, the aliphatic urethane (meth)acrylate functional oligomer comprises a urethane which is the reaction product of three moles of a triisocyanate such as an aliphatic triisocyanate, such as hexamethylene triisocyanate (HMTI) an alicyclic triisocyanate, such as dicyclohexyl methane diisocyanate (H₁₂MTI), with one and a half moles of propylene glycol or ethylene glycol. Further, the preferred aliphatic urethane (meth)acrylate functional oligomer comprises the reaction product of the urethane and a hydroxyalkyl (meth)acrylate in an equimolar amount of the hydroxyalkyl(meth)acrylate and the triisocyanate.

Preferably, the aliphatic urethane (meth)acrylate functional oligomer in accordance with the present invention contains no residual isocyanate or unreacted hydroxyalkyl groups in the hydroxyalkyl (meth)acrylate.

The molecular weight and the amount of aliphatic urethane (meth)acrylate functional oligomer as well as the isocyanurate containing (meth)acrylate of the present invention is limited in molecular weight so that the viscosity of the composition remains workable in the conditions of the methods of making a coating in accordance with the present invention.

The amount of the isocyanurate containing (meth)acrylate in accordance with the present invention is limited to insure that the viscosity of the composition remains workable in the conditions of the methods of making a coating in accordance with the present invention.

To insure proper coating hardness in accordance with the UV curing acrylic composition of the present invention, a multifunctional (meth)acrylate diluent of one or, or, preferably, two of, or, more preferably, each of (a1) an aliphatic trifunctional acrylic monomer, (a2) an aliphatic tetrafunctional acrylic monomer and (a3) an aliphatic pentafunctional acrylic monomer is present in the amount of from 3 to 25 wt. %, based on the total monomer solids of the UV curing acrylic composition.

The UV curing acrylic compositions also comprise a sufficient amount of a photoinitiator, such as camphorquinone, to insure cure in a reasonable time, such as from 2-10 wt. %, or, preferably, from 3-7 wt. %, based on monomer solids.

Suitable photoinitiators may include, for example, α-hydroxyketones, such as DAROCUR™ 1173, a 2-Hydroxy-2-methyl-1-phenyl-propan-1-one (BASF, Germany), benzophenones, benzoin dimethyl ether, 2-hydroxyl-2-methyl-1-phenyl acetone, 1-hydroxyl-cyclohexyl phenyl acetone, phenylglyoxylates, 1, 2, 2-dimethoxy, 2-diphenyl butanone, di(2, 4, 6-trimethyl benzoyl) phenylphosphine oxide, benzyldimethyl-ketal, alpha-aminoketone, monoacyl phosphines, bis-acyl phosphines, phosphine oxides and diethoxyacetophenone (DEAF), and their mixtures (Esacure KTO 46 from IGM).

Examples of commercially available photoinitiators may also include ESACURE™ ONE (IGM Resins BV, Waalwijk, NL, CAS: 163702-01-0 oligo(2-hydroxy-2-methyl-1-[4-(1-methylvinyl)phenyl]propanone) and OMNIPOL™ BP ((IGM, CAS 515136-48-8, α-[(4-benzoylphenoxy)acetyl]-ω-[[2-(4-benzoylphenoxy)acetyl]oxy]-poly(oxy-1,4-butanediyl)).

To insure their transparency and limit viscosity, the UV curing acrylic compositions of the present invention contain 5 wt. % or less of inorganic fillers or additives, such as fillers or extenders. The term “filler” and the term “extender” can be used interchangeably. Inorganic additives can negatively affect the thermo-formability and can cause haze or limit elongation.

Solvents as diluents can be added to tune viscosity of the UV curing acrylic composition in order to satisfy the coating requirement. Suitable solvents are generally liquids which are inert toward the (meth)acrylate monomers under the reaction conditions, examples being ethers such as ethylene glycol ethers and ethylene diglycol ethers; esters such as butyl acetate; ketones such as methyl amyl ketone; and aliphatic alcohols, such as isopropanol, etc. Preferred is propylene glycol methyl ether acetate (PGMEA).

The UV curing acrylic compositions in accordance with the present invention can further comprise fluorinated additives, silicone containing additives, such as mold release agents, slipper agents, and/or anti-fingerprint agents, etc. in the amount of less than 5 wt. %, based on total solids or, preferably, from 0.1 to 3 wt. % of solids.

In a second aspect, the present invention provides multilayer films for protecting curved optical displays which comprise the thermoformable hardcoat of the present invention, a transparent substrate, such as an polymer film, and an optical adhesive for bonding the film to the optical display. The transparent substrate may be, for example, polyethylene terephthalate (PET) or a polyimide, but could be other polymers, such as polycarbonate and PMMA.

In a third aspect, the present invention provides methods of making the thermoformable hard coats comprising curing the UV curing reaction mixture of the present invention, Additional thermal treatment steps before and after UV curing, such as tempering at from 50-90° C. may be useful to tune the coating properties. In addition, humidity treatments during and after curing are not necessary to make the coating of the present invention.

### EXAMPLES

The following Examples seek to illustrate the present invention.

All materials including photoradical initiators, (meth)acrylate monomers, aliphatic urethane (meth)acrylate functional oligomers, solvents, polyethylene terephthalate (PET) (Mellinex™ 462 polyester, Tekra, a division of EIS, Inc., New Berlin, Wis.), were used as received unless specified otherwise.

The abbreviations or names given to materials used in the Examples below have the following meanings:

The following test methods were used in the following Examples:

Elongation-to-Break:

An Instron mechanical tester was used to measure the elongation-to-break of coatings. Cured coatings on PET substrates were cut to specimens in 15 mm wide and ˜100 mm long. Next, specimens with 60 mm gauge length were gripped by pneumatic grips and then preloaded to 1 MPa in tensile stress. Then, the specimens were loaded in tension at the loading rate of lmm/min until a vertical crack is observed. During the tensile test, the specimens were under a white LED light for easier crack detection. Once a crack was found in the specimens, the loading was immediately stopped and corresponding tensile strain was reported as elongation-to-break. A result of at least >2% is acceptable. >4% is preferred.

Haze:

A BYK haze measurement system (Byk Gardner, Geretsried, Del.) was used to measure the haze of the indicated coatings. The haze values were obtained based on ASTMD1003 standard (2013). A % transparency of >90% (550 nm) and a % haze<2 is acceptable. The same transparency and % Haze below 1 is preferred.

Indentation modulus (E, GPa) and hardness (H, GPa):

A Nanoindenter iMicro™ (Nanomechanics, Tenn.) was used to characterize the indentation modulus and hardness of cured hard coatings. The nanoindenter had load and displacement resolutions of 6 nN and 0.04 nm, respectively and was operated in continuous stiffness mode in which the indenter tip was continuously oscillated at a 2 nm amplitude for improved surface detection and extraction from a single measurement of mechanical properties as a function of indentation depth. A standard Berkovich tip whose projected contact area function was calibrated to an indentation depth of from 200 and 2000 nm was used by making 20-25 indentations on a fused silica specimen with an indentation modulus of 72 GPa±1 GPa. The indicated cured hard coatings were mounted on sample holders using a hot melt adhesive with a melting point of circa 54° C. (Crystal Bond™ 555, TedPella, Inc., Redding, Calif.). Indentations to 2000 nm depth were made on each coating in at least 10 different locations once the test system had reached a thermal drift of <0.1 nm/sec. A Poisson's ratio of 0.3 was assumed. Subsequent to the measurement, 3 to 5 indentations were again made on the fused silica specimen to verify the previous calibration. Adequate hardness comprises a modulus greater than 4 GPa and a hardness at least >0.3 GPa.

Outward Bending Radius:

The outward bending radius of cured coatings was measured using a manual cylindrical bend tester (TQC). The tester is equipped with smooth metal mandrels having different diameters (32, 25, 20, 19, 16, 13, 12, 10, 8, 6, 5, 4, 3, and 2 mm) to apply discrete sets of strain to cured coatings. Cured coatings with a thickness ˜50 μm on 50 μm PET were used. One side of the cured film was fixed at the bottom of the equipment, and a smooth metal mandrel with a desired diameter was set in the tester. Note that for the initial test, mandrels with sufficiently large diameters were chosen not to cause cracking in cured coatings. Then, the cured coating was lightly sandwiched between the mandrel and plastic cylinders such that only tensile bending strain is applied to the top side of the coatings. Subsequently, the cured coating was bent to the radius of the metal mandrel. After the bending, the coating was detached from the tester for visual crack detection. This process was repeated until a crack was formed. Once a crack was detected, the smallest mandrel diameter without cracking was converted into an outward bending radius (dividing diameter by 2) and reported. Bending radius below and/or equal to 1.5 mm is acceptable; and below 1 mm is preferred. Pencil hardness: Pencil hardness (ASTM standard D3363 (2011) measurements of coatings cured as indicated were measured using an automatic pencil hardness tester (PPT-2016, Proyes International Corp., TaiChung, Taiwan). The test was performed at a 10 mm/min in speed and at a 0.75 kgf vertical load using UNI™ pencils (Mitsubishi, Japan). During testing, the cured coatings were placed on a flat, clean and 0.5 cm thick glass plate. An acceptable result is greater than or equal to 4H.

Hard Coating Thickness:

Coating thickness was measured by a micro-meter (Mitsutoyo, Japan). The micro-meter was re-zeroed before measurements, and subsequently multiple locations on a given hard coating were measured.

The UV curing acrylic compositions indicated in Tables 1 and 2, below, were prepared by mixing the indicated constituents using a vortex and optionally a speed mixer at room temperature. The final compositions were left on a slow rotary mixer for from 1 hour to 72 hours until all of the components were dissolved and become clear solution in an ambient lab environment to ensure homogenous mixing before film preparation. Preferably, the total mixing time is 1-24 hours. the solution can also be heated up to 60° C. during the mixing.

Film Casting:

PET substrates were cleaned with a jet of filtered laboratory air. An automatic draw-down coater (ElcometerUSA, Rochester Hills, Mich.) was used to cast the indicated compositions on PET substrates at room temperature. Draw-down bars with different gaps were used to obtain desired coatings at a thickness of ˜40 um. The films were then UV-cured using a Fusion™ 300 conveyor system (irradiance ˜3000 mW/cm², Fusion Systems, Inc., Gaithersburg, Md.). Each film passed the lamp four times 0.24 m/s. The average values for energy density at 0.24 m/s are around 480, 120, 35, and 570 mJ/cm² in the UVA, UVB, UVC, and UVV regimes, respectively.

In the Examples below, the following materials were used:

DPEPA: Dipentaerythritol pentaacrylate ester: (SR399™ Sartomer, Exton, Pa.), CAS#60506-81-2<=100 wt. %; SR399 is a mixture of tetra-, penta-, and hexa-acrylate; Tentative molar ratio of acrylates is 25:50:25;

MEDA: 2-Propenoic acid, (5-ethyl-1,3-dioxan-5-yl)methyl ester: SR531 (Sartomer, f=1 CAS#66492-51-1, <=95%); also includes a) 2-Propenoic acid, 2-ethyl-2-[[(1-oxo-2-propenyl)oxy]methyl]-1,3-propanediyl ester, f=3 CAS#15625-89-5, <=5%; b) Phenol, 2,6-bis(1,1-dimethylethyl)-4-methyl-(aka BHT), CAS #128-37-0, <=1%; and c) 2-Propenoic acid (acrylic acid), f=1, CAS#79-10-7, <=0.1%;

Monomer 2: Isobornyl acrylate, SR506C (Sartomer, f=1 CAS#5888-33-5,);

THEIA: Tris (2-hydroxyethyl)isocyanurate triacrylate: Photomer™ 4356 (IGM, United States, f=3, Cas#40220-08-4, >98%; also includes acrylic acid, <1%;

Photoinitiator 1: Oligo[2-hydroxy-2-methyl-1-[4-(1-methylvinyl)phenyl]propanone] (Esacure™ One, IGM Resins B. V., Waalwijk, NL. CAS#163702-01-0);

Photoinitiator 2: Omnipol™ BP (CAS 515136-48-8, α-[(4-benzoylphenoxy)acetyl]-w-[[2-(4-benzoylphenoxy)acetyl]oxy]-poly(oxy-1,4-butanediyl))

HUA; Aliphatic urethane acrylate: CN9006 (Sartomer, f=6, CAS# proprietary, >=30-<60% (GPC analysis of main oligomer: Mw=1.5 kDa, Mn=1.3 kDa, PDI=1.20); also includes a) 2-Propenoic acid, 2-(hydroxymethyl)-2-[[(1-oxo-2-propenyl)oxy]methyl]-1,3-propanediyl ester, f=3; CAS#3524-68-3, >=10-<30%; b) 2-Propenoic acid, 2,2-bis[[(1-oxo-2-propenyl)oxy]methyl]-1,3-propanediyl ester, f=4; CAS#4986-89-4, >=10-<30%; other acrylates, f=unknown, >=10-<30%;

Urethane nonaacrylate: CN9013 (Sartomer, f=9, CAS proprietary, <=100%);

Silicone (non-reactive): BYK307™ additive (BYK USA, Chester, Pa.);

Alumina oxide: BYK3601 (BYK);

HUA 2: Urethane acrylate CN9025 (Sartomer, CAS# Proprietary aliphatic, f=6, >=60-<=100%; also contains Proprietary Acrylic ester, f=6>=10-<30%);

TUA: urethane acrylate oligomer: Photomer™ 6008 (IGM, CAS proprietary, f=3); also contains tripropylene glycol diacrylate, CAS#42978-66-5, 15-25%; b) 2-hydroxyethyl acrylate, CAS#818-61-1, <2%;

Alicyclic TUA: Methylenedi-4,1-cyclohexyleneisocyanate, (2-hydroxyethyl)-2-propenoate, α-hydro-ω-hydroxypoly(oxy-1,4-butanediyl)polymer: Photomer™ 6010 (IGM, CAS#67599-25-1, f=3, >85%); also contains a) ethoxylated (3) trimethylolpropane triacrylate, CAS#28961-43-5, f=3, >10-<15%; b) 2-hydroxyethyl acrylate, <1%; c) hydroquinone<0.05%; and,

Silica: X12-2444 silica nanoparticles in multifunctional acrylate (Shin Etsu Chemical, Ltd., Tokyo, JP).

TABLE 1
Inventive Compositions and Performance

| | Example¹ | | |
|---|---|---|---|
| | 1 | 2 | 3 |
| MEDA | 10 | 10 | 10 |
| (acrylate monomer (f = 1)) | | | |
| DPEPA | 20 | 20 | 10 |
| Acrylate monomer f = 5 | | | |
| THEIA | 20 | 20 | 30 |
| Acrylate monomer with isocyanurate | | | |
| HUA: Urethane oligomer (f = 6) | 45 | 20 | 35 |
| Acrylate monomer (f = 3) | | | |
| Acrylate monomer (f = 4) | | | |
| Urethane nonaacrylate (f = 9) | — | 25 | — |
| Photoinitiator 2 | 2 | 2 | 2 |
| Photoinitiator 1 | 3 | 3 | 3 |
| Pencil hardness | 7H | 4H | 7H |
| (0.75 kg, thickness 50 μm) | | | |
| Outward radius (mm); | <1; | <1; | <1; |
| Thickness (μm) | 13 | 9 | 9 |

¹f represents functionality.

As shown in Examples 1 to 3, the inventive compositions provide hard coatings having both acceptable pencil hardness and flexibility, as shown in outward radius.

TABLE 2
Comparative Compositions and Performance

| Example¹ | 4* | 5* | 6* | 7* | 8* | 9* |
|---|---|---|---|---|---|---|
| MEDA | 10 | 10 | 10 | 10 | 10 | 10 |
| (acrylate monomer (f = 1)) | | | | | | |
| ??mer 2? | 20 | 20 | 20 | 20 | 20 | — |
| (acrylate monomer (f = 1)) | | | | | | |
| DPEPA | — | — | — | — | — | 20 |
| Acrylate monomer f = 5 | | | | | | |
| THEIA | — | — | — | 30 | 25 | 20 |
| Acrylate monomer with isocyanurate | | | | | | |
| Silica | — | — | 20 | — | — | — |
| HUA: Urethane oligomer (f = 6) | 65 | — | 45 | 35 | 50 | — |
| Acrylate monomer (f = 3) | | | | | | |
| Acrylate monomer (f = 4) | | | | | | |
| TUA (f = 3) | — | 65 | — | — | — | — |
| Urethane nonaacrylate (f = 9) | — | — | — | — | — | 45 |
| Photoinitiator 2 | 2 | 2 | 2 | 2 | 2 | 2 |
| Photoinitiator 1 | 3 | 3 | 3 | 3 | 3 | 3 |
| Pencil hardness | 2 H | <6 B | 2 H | 3 H | H | 3 H |
| (0.75 kg, thickness 50 μm) | | | | | | |
| Outward radius (mm); | — | — | — | <1; | <1; | <1; |
| Thickness (μm) | | | | 10 | 7 | 9 |

¹*Denotes Comparative Example;
¹f represents functionality.

As shown in Table 2, above, none of the Comparative Examples 4 to 9 gave the acceptable pencil hardness for a thermoformable coating in accordance with the present invention. All of Comparative Examples 4 to 8 contain too much mono (meth)acrylate monomer; this is so even when the example contains adequate aliphatic urethane (meth)acrylate functional oligomer and isocyanurate (meth)acrylate monomer, as in Comparative Examples 7, and 8. Comparative Example 9 fails to contain any aliphatic tetrafunctional (meth)acrylate. Comparative Example 6 contains too much silica or filler.

We claim:

1. An ultraviolet (UV) curing acrylic composition for use in making thermoformable hard coats for curved optical displays comprising: (a) one or more multifunctional (meth)acrylate diluents chosen from (a1) an aliphatic trifunctional (meth)acrylate monomer; (a2) an aliphatic tetrafunctional (meth)acrylate monomer or (a3) an aliphatic pentafunctional (meth)acrylate monomer; (b) from 3 to 30 wt. %, based on the total weight of monomer solids, of one or more (meth)acrylate monomer containing an isocyanurate group; (c) from 5 to 40 wt. %, based on the total weight of monomer solids, of one or more aliphatic urethane (meth)acrylate functional oligomer having from 6 to 12 (meth)acrylate groups; (d) from 2 to 10 wt. %, based on total monomer solids, of one or more UV radical initiators; (e) one or more organic solvents for the monomer composition, wherein the composition has a viscosity measured by Anton Parr ASVM 3001, at 50 wt. % solids of from 10 to 200 centipoise (cPs), wherein the total amount of monomer and functional oligomer solids amounts to 100%.

2. The composition as claimed in claim 1 comprising: from 3 to 25 wt. %, based on total monomer solids, of (a) the multifunctional (meth)acrylate diluent (a1) one or more aliphatic trifunctional (meth)acrylate monomer, wherein the total amount of monomer and functional oligomer solids amounts to 100%.

3. The composition as claimed in claim 1 comprising: from 3 to 25 wt. % or, based on total monomer solids, of (a) the multifunctional (meth)acrylate diluent (a2) one or more aliphatic tetrafunctional (meth)acrylate, monomer, wherein the total amount of monomer and functional oligomer solids amounts to 100%.

4. The composition as claimed in claim 1 comprising: from 3 to 25 wt. %, based on total monomer solids, of (a) the multifunctional (meth)acrylate diluent (a3) one or more aliphatic pentafunctional (meth)acrylate, monomer, wherein the total amount of monomer and functional oligomer solids amounts to 100%.

5. The composition as claimed in claim 1 comprising: from 9 to 70 wt. % in total, based on total monomer solids, of (a) two or more multifunctional (meth)acrylate diluent monomers chosen from the (a1) aliphatic trifunctional (meth)acrylate monomer, (a2) the aliphatic tetrafunctional (meth)acrylate monomer or (a3) the aliphatic pentafunctional (meth)acrylate monomer, wherein the total amount of monomer and functional oligomer solids amounts to 100%.

6. The composition as claimed in claim 1 comprising: (b) from 10 to 30, based on the total weight of monomer solids, of one or more one (meth)acrylate monomer containing an isocyanurate group, wherein the total amount of monomer and functional oligomer solids amounts to 100%.

7. The composition as claimed in claim 1 comprising: (c) from 10 to 40 wt. %, based on the total weight of monomer solids, of one or more aliphatic oligomer having from 6 to 12 (meth)acrylate groups, wherein the total amount of monomer and functional oligomer solids amounts to 100%.

8. The composition as claimed in claim 1, wherein the at least one (c) aliphatic urethane (meth)acrylate functional oligomer has a formula molecular weight of from 1,400 to 10,000.

9. The composition as claimed in claim 1 comprising: 20 wt. % or less in total of mono- and di-functional (meth)acrylates, based on total monomer solids, wherein the total amount of monomer and functional oligomer solids amounts to 100%.

10. The composition as claimed in claim 1, wherein the amount of the (e) one or more organic solvents ranges from 10 to 90 wt. %, based on the total weight of the composition.
